(19) United States
(12) Patent Application Publication
(10) Pub. No.: US 2013/0321336 A1
(43) Pub. Date: Dec. 5, 2013

(54) Method for Acquiring Information, Electronic Device and Identifier Apparatus

(71) Applicants: Beijing Lenovo Software Ltd., Beijing (CN); Lenovo (Beijing) Co., Ltd., Beijing (CN)

(72) Inventors: Jun Li, Beijing (CN); Jinshan Chen, Beijing (CN); Yongqiang Zhang, Beijing (CN); Xin Li, Beijing (CN); Cheng Guo, Beijing (CN); Hao Wang, Beijing (CN)

(21) Appl. No.: 13/909,528

(22) Filed: Jun. 4, 2013

(30) Foreign Application Priority Data
Jun. 5, 2012 (CN) CN 201210184279.4
Jun. 28, 2012 (CN) CN201210224407.3

(51) Int. Cl. G06F 3/041; H04B 5/00

(52) U.S. Cl. CPC G06F 3/0416; H04B 5/0031
USPC 345/174; 345/156

(57) ABSTRACT

A method for acquiring information, an electric device and an identifier apparatus are described. The electronic device includes a wireless receiving apparatus capable of receiving information from a trigger object, and a display screen, the trigger object includes at least three surfaces each of which has a corresponding wireless communication apparatus. The method includes detecting trigger information from the wireless communication apparatus in the trigger object; determining a first surface among the at least three surfaces corresponding to the trigger information; acquiring first wireless RF information transmitted from the wireless communication apparatus corresponding to the first surface; and determining data information on the first surface corresponding to the first wireless RF information, according to the correspondence between wireless RF information and surface information.

This application claims priority to Chinese patent application No. CN 201210184279.4 filed Jun. 5, 2012 and Chinese patent application no. CN201210224407.3 filed Jun. 28, 2012, the entire contents of each are incorporated herein by reference.

### BACKGROUND

The present disclosure relates to the field of electronic technique, especially to a method for acquiring information, an electronic device and an identifier apparatus.

With the fast development of the electronic communication products, the electronic device has increasingly diversified functions. In the prior art, a tablet computer or a mobile phone with a touch screen has been widely applied. The user thus may play game or perform other operations by touch operations on the tablet computer or the mobile phone with the touch screen. For example, when the user inputs information to the tablet computer of a large size with a trigger object, the user needs to use the trigger object on the tablet computer to obtain the information on the trigger object. In the prior art, the user needs to input the information on the trigger object into the tablet computer to complete the input of the information, which makes the operation process of the user very complicated.

Further, a trigger object with a gyro or a gravity sensor is provided in the prior art. The problem of the necessity of the manual input by user is solved by determining the information on the trigger object by the gyro. However, a power supply is required in the trigger body by the gyro or the gravity sensor. Then, it shortens the lifetime of the trigger object, also, the cost of the trigger object is increased with the installation of the gyro or the gravity sensor in the trigger object.

On the other hand, with the development of the technology, the terminal device with a (capacitive) touch screen, such as the multimedia information kiosk in the shopping mall or the street, or the information terminal in the corporation, is installed in more and more regions such as the shopping mall or the office, so that the user may obtain some information by way of touch. However, the current terminal device with the touch screen cannot recognize the type and/or the kind of the object on the touch screen thereof, as well as the placing direction of the object.

### SUMMARY

In view of the above, the embodiments of the disclosure provide a method for acquiring information, an electronic device and an identifier apparatus, which does not need the provision of the power supply in the trigger object, so that it can improve the lifetime of the trigger object.

According to an aspect of the present disclosure, a method for acquiring information is provided, applied to an electronic device comprising a wireless receiving apparatus capable of receiving information from a trigger object, and a display screen, the trigger object comprising at least three surfaces each of which has a corresponding wireless communication apparatus, the method comprising: detecting trigger information from the wireless communication apparatus in the trigger object; determining a first surface among the at least three surfaces corresponding to the trigger information, based on the trigger information; acquiring first wireless RF (Radio Frequency) information transmitted from the wireless communication apparatus corresponding to the first surface; and determining data information on the first surface corresponding to the first wireless RF information, according to the correspondence between wireless RF information and surface information.

Optionally, the wireless communication apparatus is a Near Field Communication (NFC) apparatus.

Optionally, the step of acquiring the first wireless RF information transmitted from the wireless communication apparatus corresponding to the first surface comprises: transmitting to the NFC apparatus starting information for generating the wireless RF information by the NFC apparatus; and acquiring the wireless RF information generated by the NFC apparatus in the first surface, and determining the first wireless RF information according to the wireless RF information.

Optionally, the correspondence between wireless RF information and surface information is set in such a way that one piece of wireless RF information corresponds to data information on one surface uniquely.

Optionally, the step of determining the first wireless RF information based on the wireless RF information comprises: obtaining at least two pieces of wireless RF information through a wireless RF information receiving apparatus; deciding whether the at least two pieces of wireless RF information meet a preset condition or not, to make a decision; when the decision shows that the two pieces of wireless RF information meet the preset condition, determining the first wireless RF information according to the two pieces of wireless RF information; and determining the data information on the first surface according to the first wireless RF information.

Optionally, the method further comprises: when the decision shows that none of the two pieces of wireless RF information meets the preset condition, returning to detect the trigger information from the wireless communication apparatus in the trigger object.

Optionally, the preset condition is that the value of the difference between the at least two pieces of wireless RF information is within a preset range.

Optionally, before the step of deciding whether the at least two pieces of wireless RF information meet a preset condition or not to make a decision, the method further comprises: deciding whether the time interval between the timings when acquiring the two pieces of wireless RF information meets a preset time or not; if the time interval between the timings when acquiring the two pieces of wireless RF information meets the preset time, deciding whether the two pieces of wireless RF information meet the preset condition.

According to another aspect of the present disclosure, an electronic device is provided, comprising: a detector configured to detect trigger information from a wireless communication apparatus in a trigger object; a determining module configured to determine a first surface among at least three surfaces corresponding to the trigger information, based on the trigger information; an information acquiring module configured to acquire first wireless RF information transmitted from the wireless communication apparatus corresponding to the first surface; and a data information determining module configured to determine data information on the first surface corresponding to the first wireless RF information, according to the correspondence between wireless RF information and surface information.

Optionally, the information acquiring module comprises: a transmitter configured to transmit to the NFC apparatus starting information for generating the wireless RF information by the NFC apparatus; and a first determining module configured to acquire the wireless RF information generated by the NFC apparatus in the first surface, and determine the first wireless RF information according to the wireless RF information.

According to another aspect of the present disclosure, an identifier apparatus is provided, comprising: a substrate having a first surface and a second surface opposite to the first surface; and at least one electric conductor placed on a preset area of the first surface of the substrate; wherein, the second surface of the substrate is connectable to a first object; and the at least one electric conductor on the first surface of the substrate forms an identity for identifying the first object, when the at least one electric conductor is contacted with a touch screen of a terminal device.

In addition, according to an embodiment of the present disclosure, a pit array is arranged on the first surface of the substrate, and the at least one electric conductor is arranged on preset pits in the pit array.

In addition, according to an embodiment of the present disclosure, the pit array is a M×N pit array, wherein, M is equal to or larger than 3, and N is equal to or larger than 3.

In addition, according to an embodiment of the present disclosure, the identifier apparatus comprises a first electric conductor, a second electric conductor and a third electric conductor; and the three electric conductors form a triangular structure.

In addition, according to an embodiment of the present disclosure, the positions of the first electric conductor and the second electric conductor are fixed; and the position of the third electric conductor is determined based on the type and/or the model of the first object.

In addition, according to an embodiment of the present disclosure, the terminal device determines the positions of the first electric conductor, the second electric conductor and the third electric conductor, when the first electric conductor, the second electric conductor and the third electric conductor of the substrate are contacted with the touch screen of the terminal device; the terminal device determines the triangular structure formed of the first electric conductor, the second electric conductor and the third electric conductor, based on the positions of the first electric conductor, the second electric conductor and the third electric conductor; and the terminal device determines the type and/or the model of the first object based on the triangular structure.

In addition, according to an embodiment of the present disclosure, the terminal device determines the placing direction of the first object based on the orientation of the triangular structure.

In addition, according to an embodiment of the present disclosure, the substrate is a conductive substrate; and the at least one electric conductor is set on the preset pits of the pit array by means of magnetic connection.

In addition, according to an embodiment of the present disclosure, the touch screen is a capacitive touch screen.

According to another aspect of the present disclosure, a device is provided, comprising: a casing; and an identifier apparatus arranged on the casing, the identifier apparatus comprising: a substrate having a first surface; and at least one electric conductor placed on a preset area of the first surface of the substrate; wherein, the at least one electric conductor forms an identity for identifying the device uniquely by a terminal device, when the device is contacted with a touch screen of the terminal device so that the touch screen senses the at least one electric conductor.

In addition, according to an embodiment of the present disclosure, a pit array is arranged on the first surface of the substrate, and the at least one electric conductor is arranged on preset pits in the pit array.

In addition, according to an embodiment of the present disclosure, the identifier apparatus comprises a first electric conductor, a second electric conductor and a third electric conductor; and the three electric conductor form a triangular structure.

In addition, according to an embodiment of the present disclosure, the positions of the first electric conductor and the second electric conductor are fixed; and the position of the third electric conductor is determined based on the type and/or the model of the device.

In addition, according to an embodiment of the present disclosure, the substrate is a conductive substrate; and the at least one electric conductor is set on the preset pits of the pit array by means of magnetic connection.

According to another aspect of the present disclosure, a terminal device is provided, comprising: a touch screen configured to sense contact with the touch screen by a sensed object; a processor configured to determine the contact position based on the touch screen; and a storage configured to store multiple pieces of identifying information each of which indicating one kind of object corresponds to a specific shape; wherein, when the object is contacted with the touch screen of the terminal device, the touch screen senses at least one contact point, the at least one contact point is formed by at least one conductor on an identifier apparatus of the object; the processor determines a first shape based on the at least one contact point, compares the first shape with the multiple pieces of identifying information, and determines the type or the module of the object based on the comparison result.

In addition, according to an embodiment of the present disclosure, a pit array is arranged on the first surface of the substrate, and the at least one electric conductor is arranged on preset pits in the pit array.

In addition, according to an embodiment of the present disclosure, the identifier apparatus comprises a first electric conductor, a second electric conductor and a third electric conductor; and the three electric conductor form a triangular structure; wherein, when the first electric conductor, the second electric conductor and the third electric conductor of the substrate are sensed by the touch screen, the processor determines the positions of the contact points formed by the first electric conductor, the second electric conductor and the third electric conductor; the processor determines a triangular structure based on the positions of the contact points formed by the first electric conductor, the second electric conductor and the third electric conductor; and the processor compares the triangular structure with the multiple pieces of identifying information, and determines the type or the model of the object based on the comparison result.

In addition, according to an embodiment of the present disclosure, the processor determines the placing direction of the object based on the orientation of the triangular structure.

With the method for acquiring information, the electronic device and the identifier apparatus of the embodiments of the present disclosure, the electronic device can complete the acquisition of data information without any power supply in the trigger object, so that it prolongs the lifetime of the trigger object and reduces the power consumption.

### BRIEF DESCRIPTION OF THE DRAWINGS

The present disclosure will become more fully understood from the detailed description given hereinafter and the accompanying drawings which are given by way of illustration only, and thus are not limitative of the present disclosure and wherein:

FIG. 1 is a flowchart of a method for acquiring information according to an embodiment of the disclosure;

FIG. 2 is a schematic diagram of a detailed structure of an electronic device according to an embodiment of the disclosure;

FIGS. 3A and 3B are schematic diagrams illustrating an identifier apparatus according to an embodiment of the disclosure; and

FIG. 4 is a schematic diagram illustrating a terminal device according to an embodiment of the disclosure.

### DETAILED DESCRIPTION

In order to solve the problem that the trigger object needs a power supply and thus the lifetime of the trigger object shortens in the prior art, the present disclosure provides a method for acquiring information and an electronic device, by the Near Field Communication apparatus (NFC) of which, the information carried by the trigger object may be transmitted to the corresponding electronic device, without any power supply in the trigger object. The technical solution of the present disclosure will be further explained with reference to the figures as well as the specific embodiments. It should be noted that the specific embodiments described herein are only used to explain the present disclosure, and are not limiting. The embodiments and the features in the embodiments of the present disclosure may be combined with each other without any confliction.

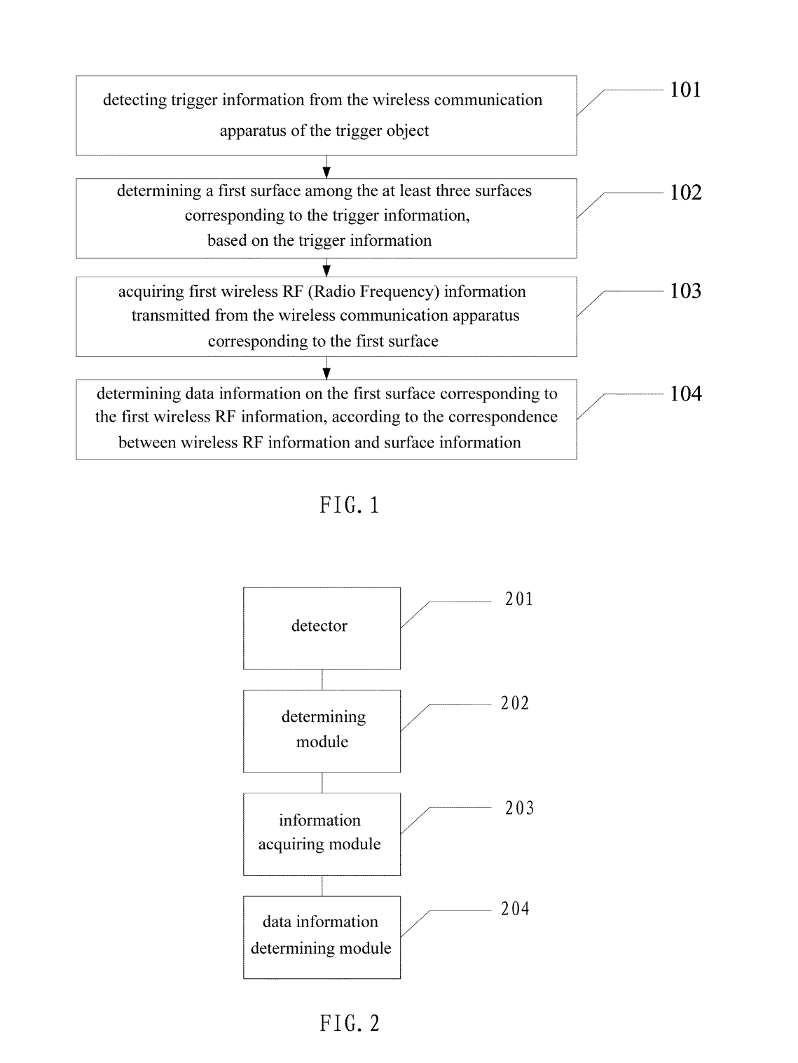

FIG. 1 is a flowchart showing a method for acquiring information in the present disclosure. The method is applied to an electronic device comprising a wireless receiving apparatus capable of receiving information from a trigger object. The trigger object comprises at least three surfaces each of which has a corresponding wireless communication apparatus. The method comprises:

Step 101, detecting trigger information from the wireless communication apparatus in the trigger object.

In the present disclosure, the electronic device will detect whether there is the trigger information or not in a preset area in real time. The trigger information is used for the electronic device to recognize (i.e., identify) the trigger object. Therefore, there is a wireless communication apparatus installed in the trigger object of the present disclosure. The wireless communication apparatus is capable of generating the trigger information, and the trigger information corresponding to each surface of the trigger object is different. The trigger information may be transmitted through magnetic wave, and thus the magnetic wave generated in each surface of the trigger object is different.

The trigger information generated in the trigger object of the present disclosure does not require any power supply. Therefore, a NFC apparatus is arranged in each surface of the trigger object. When the trigger object comes to the detectable area of the electronic device, the electronic device will detect the trigger information of the NFC apparatus in the trigger object. The electronic device will perform the process of Step 102 after receiving the trigger information.

Step 102, determining a first surface among the at least three surfaces corresponding to the trigger information, based on the trigger information.

In Step 101, the electronic device has already detected the trigger information of the NFC apparatus, wherein the trigger information of each surface of the NFC apparatus is different. Therefore, after detecting the trigger information, the electronic device will determine the first surface of the trigger object corresponding to the detected trigger information, based on the correspondence between preset information corresponding to each surface and the trigger information.

In the present disclosure, in order to make the detection result more accurate, when the electronic device detects the trigger information of the trigger object, it firstly stores the trigger information received for the first time. Then when the trigger information is received for the second time, the electronic device will determine the time difference between the timing when the trigger information is received for the second time and the timing when the trigger information is received for the first time. If the time difference is within a preset time, the electronic device will compare the trigger information received for the second time to the trigger information received for the first time. If the trigger information received for the first time and the trigger information received for the second time are the same, or the difference between them is within a preset range, the electronic device determines the trigger information is the determined trigger information.

If the time difference between the timing when the trigger information is received for the second time and the timing when the trigger information is received for the first time is not within the preset time range, the electronic device will carry out the detection again.

When the first surface is determined, the electronic device goes to Step 103.

Step 103, acquiring first wireless RF (Radio Frequency) information transmitted from the wireless communication apparatus corresponding to the first surface.

Before the electronic device acquires the first wireless RF information corresponding to the first surface of the trigger object, the electronic device transmits start information to the trigger object for starting up the NFC apparatus in the trigger object. After the NFC apparatus receives the starting information, the NFC apparatus in the trigger object will generate the wireless RF information, so that the wireless receiving apparatus in the electronic device can receive the wireless RF information transmitted from the NFC apparatus.

After the electronic device receives the wireless RF information, the electronic device will invoke the pre-stored correspondence between the data information on each surface of the trigger object and the wireless RF information, to determine the surface information corresponding to the received wireless RF information.

In the present disclosure, in order to make the data information on the surface of the trigger object more accurate, the electronic device will acquire the wireless RF information transmitted from the trigger object at least twice. Specially, after the electronic device acquires the wireless RF information for the first time, the electronic device stores the wireless RF information, and then continues to detect the wireless RF information. After the electronic device acquires the wireless RF information for the second time, the electronic device will compare the wireless RF information received for the second time with the wireless RF information received for the first time. Specially, the electronic device will firstly determine whether the wireless RF information received for the first time is identical to the wireless RF information received for the second time or not. If not, the electronic device will discard the wireless RF information received for the first time, and stores the wireless RF information received for the second time, and continue to detect the wireless RF information transmitted from the trigger object.

If the wireless RF information received for the first time is identical to the wireless RF information received for the second time, the electronic device will determine the time difference between the timing when the wireless RF information is received for the first time and the timing when the wireless RF information is received for the second time. If the time difference meets the preset time difference, the electronic device will determine the first wireless RF information according to the wireless RF information received for the first time and the wireless RF information received for the second time. After determining the first wireless RF information, the electronic device goes to Step 104.

Step 104, determining data information on the first surface corresponding to the first wireless RF information, according to the correspondence between wireless RF information and surface information.

The first wireless RF information determined in the above way will be more accurate, so that the electronic device determines the data information on the first surface corresponding to the first wireless RF information, by the determined first wireless RF information, wherein, each piece of wireless RF information corresponds to data on one surface uniquely.

Of course, when the time difference between the timing when the wireless RF information is received for the first time and the timing when the wireless RF information is received for the second time is beyond the preset time difference, the electronic device will delete the stored wireless RF information received for the first time, and go back to detect the trigger information from the NFC apparatus in the trigger object.

With the above technical solution, the trigger object requires no power supply, and the electronic device can acquire the trigger information from the NFC apparatus in the trigger object, and thus determine the surface of the trigger object corresponding to the trigger information, finally determine the data information corresponding to the surface by the wireless RF information in the NFC apparatus. Thereby, the electronic device can complete the acquisition of data information without any power supply in the trigger object, so that it prolongs the lifetime of the trigger object and reduces the power consumption.

The technical solution of the present disclosure will be described further in combination with a detailed application environment.

When the user needs to play a game with dice, for example, the Rich, on a tablet with a large size, after the electronic device enters into the game interface, firstly, the user needs to throw the electric dice on the touch screen of the tablet. A NFC apparatus is arranged on each surface of the electric dice. The pip count of the electric dice thrown by the user will be determined by the tablet through the apparatus. Of course, the tablet firstly receives trigger information of the electric dice by the wireless receiving apparatus, that is, detects whether there is a NFC apparatus on the electric dice.

After the tablet determines that there is the NFC apparatus in the electric dice, it transmits the trigger information to the NFC apparatus. The NFC apparatus will generate the wireless RF information after receiving the trigger information. The table will receive the wireless RF information, so that it determines the data information on the surface corresponding to the wireless RF information, based on the wireless RF information. In the electric dice, the wireless RF information on the first surface corresponds to the pip count 1 of the electric dice, the wireless RF information on the second surface corresponds to the pip count 2 of the electric dice, and so on. Therefore, after the user throws the electric dice on the touch screen of the tablet, the touch screen of the tablet will display the corresponding pip count.

The present disclosure further provides an electronic device. FIG. 2 is a schematic diagram showing the detailed structure of the electronic device in the present disclosure. The electronic device comprises:

a detector 201 configured to detect trigger information from a wireless communication apparatus of a trigger object;

a determining module 202 configured to determine a first surface among at least three surfaces corresponding to the trigger information, based on the trigger information;

an information acquiring module 203 configured to acquire first wireless RF (Radio Frequency) information transmitted from the wireless communication apparatus corresponding to the first surface; and

a data information determining module 204 configured to determine data information on the first surface corresponding to the first wireless RF information, according to the correspondence between wireless RF information and surface information.

Further, in the present disclosure, the information acquiring module comprises: a transmitter configured to transmit to the NFC apparatus starting information for starting up the NFC apparatus to generate the wireless RF information; and a first determining module.

After the NFC apparatus generates the wireless RF information, the electronic device will acquire the wireless RF information and determine the first wireless RF information according to the wireless RF information through first determining module.

Finally, the data information determining module 204 in the electronic device will acquire the first wireless RF information in the first determining module, and determine the data information on the surface corresponding to the first wireless RF information according to the first wireless RF information.

The present disclosure provides a method for acquiring information and an electronic device, the method comprising: detecting trigger information from the wireless communication apparatus in the trigger object; determining a first surface among the at least three surfaces corresponding to the trigger information, based on the trigger information; acquiring first wireless RF information transmitted from the wireless communication apparatus corresponding to the first surface; and determining data information on the first surface corresponding to the first wireless RF information, according to the correspondence between wireless RF information and surface information. Thereby, the electronic device can complete the acquisition of data information without any power supply in the trigger object, so that it prolongs the lifetime of the trigger object and reduces the power consumption.

Provided is an identifier apparatus according to the embodiment of the present disclosure. Here, the identifier apparatus according to the present embodiment may be an identifier apparatus of a tag type. The identifier apparatus according to the present embodiment may comprise a substrate and at least one electric conductor. The substrate can be implemented by a metal substrate or a non-metal substrate and may have a first surface and a second surface opposite to the first surface. The at least one electric conductor may be implemented by any conductive material and is set on a preset area of the first surface of the substrate. In addition, the second surface of the substrate is able to be connected (for example, adhered) to objects such as a mobile phone, a TPC or a cup and so on. In this case, when the identifier apparatus according to the present embodiment of the present disclosure is adhered to a specific object, and the at least one electric conductor on the first surface of the substrate is contacted with a touch screen of the terminal device (for example, a touch information kiosk and so on), the at least one electric conductor may form an identity for identifying the specific object.

Here, a pit array may be set on the first surface of the substrate, and the at least one electric conductor is set on the preset pits in the pit array. Here, the pit array may be an M×N pit array, that is, the pit array may be an array having M rows, N columns and M×N pits. Here, M and N may be an integer larger than or equal to 1. In this case, a pattern or a shape being composed of at least one electric conductor in the M×N pit array may form an object corresponding to the identifier apparatus identified by users. For example, one electric conductor in the M×N pit array may represent that the object corresponding to the identifier apparatus is a mobile phone, while two electric conductors (the two electric conductors form a straight line) in the M×N pit array may represent a cup and so on.

In addition, according to another example of the present embodiment of the present disclosure, a triangular structure may be formed using three electric conductors to identify the corresponding object. In particular, different objects may be identified according to different shapes of triangles composed of the three electric conductors.

In this case, for the M×N pit array, M is preferably larger than or equal to 3 and N is preferably larger than or equal to 3.

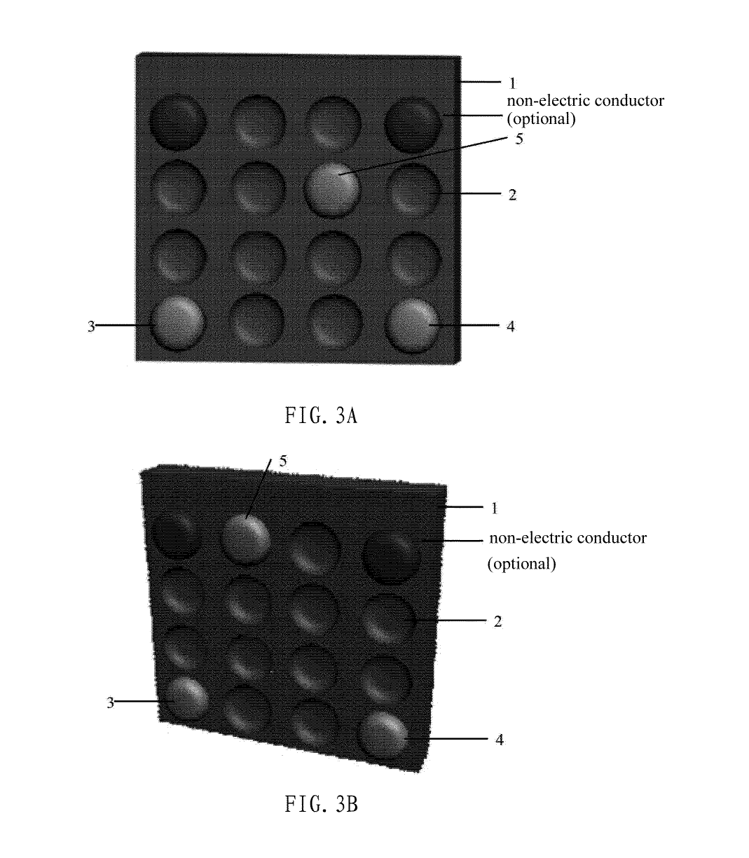

Below will be a description of an example by referring to FIGS. 3A and 3B. The identifier apparatus as shown in FIG. 3 may have a 4×4 (M and N are respectively 4) pit array.

As shown in FIG. 3A, the identifier apparatus according to the present embodiment of the present disclosure comprises a substrate 1, a pit array 2, a first electric conductor 3, a second electric conductor 4 and a third electric conductor 5. Here, the first electric conductor 3, the second electric conductor 4 and the third electric conductor 5 are respectively set on different pits in the pit array 2 on the first surface of the substrate 1, and the first electric conductor 3, the second electric conductor 4 and the third electric conductor 5 form a triangular structure.

Here, the thicknesses of the first electric conductor 3, the second electric conductor 4 and the third electric conductor 5 need to be larger than the depth of the pit in the pit array 2, so that the first electric conductor 3, the second electric conductor 4 and the third electric conductor 5 can contact with the touch screen of the electronic device respectively when the first surface of the substrate 1 contacts with the touch screen of the electronic device, thereby the electronic device can sense the first electric conductor 3, the second electric conductor 4 and the third electric conductor 5. Thus, the shape of the triangle composed of the first electric conductor 3, the second electric conductor 4 and the third electric conductor 5 can be determined based on the positions of the first electric conductor 3, the second electric conductor 4 and the third electric conductor 5 on the touch screen. For example, the triangle composed of the first electric conductor 3, the second electric conductor 4 and the third electric conductor 5 as shown in FIG. 3A may represent a mobile phone, while the triangle composed of the first electric conductor 3, the second electric conductor 4 and the third electric conductor 5 as shown in FIG. 3B may represent a cup and so on.

In addition, there may be a possibility that the positions of the first electric conductor 3, the second electric conductor 4 and the third electric conductor 5 are different but the shapes of the triangles composed thereof are be of the same, due to the random arrangement of the first electric conductor 3, the second electric conductor 4 and the third electric conductor 5 in the pit array 2. Therefore, in another example, the positions of the first electric conductor 3 and the second electric conductor 4 may be fixed, and the type and/or the model of the object corresponding to the identifier apparatus may be determined according to the position of the third electric conductor 5.

For example, as shown in FIG. 3A, the first electric conductor 3 and the second electric conductor 4 may be set in the downmost row of the pit array 2 (i.e., the 4^{th} row from the top), and the first electric conductor 3 and the second electric conductor 4 may be set at two ends (the two pits with a longest distance) of the same row respectively. In this case, as shown in FIGS. 3A and 3B, since the two points (for example, the first electric conductor 3 and the second electric conductor 4) in the triangle composed of the first electric conductor 3, the second electric conductor 4 and the third electric conductor 5 have been fixed and one side in the composed triangle has been fixed, triangles with different shapes can be formed through changing the position of the third electric conductor 5. In this case, triangles with different shapes can represent the type and/or model of the object corresponding to the identifier apparatus, and the identifier apparatuses having different shapes of triangles may be assigned with respect to the type and/or model of objects, so that the electronic device can identify them. For example, the triangle composed of the first electric conductor 3, the second electric conductor 4 and the third electric conductor 5 as shown in FIG. 3A may represent a mobile phone, while the triangle composed of the first electric conductor 3, the second electric conductor 4 and the third electric conductor 5 as shown in FIG. 3B may represent a cup and so on. In addition, in another example, in order to prevent the connecting line formed between the third electric conductor 5 and the first electric conductor 3 or the second electric conductor 4 and the connecting line formed between the first electric conductor 3 and the second electric conductor 4 from being of the same shape (it may be mistaken by the electronic device as a fixed connecting line formed between the first electric conductor 3 and the second electric conductor 4), non-electric conductors may be set at two ends (the two pits with a longest distance) of the top line (i.e., the I^{st} line from the top) of the 4×4 pit array as shown in FIG. 3A or FIG. 3B, so as to avoid the above situation.

With the above configurations, the identifier apparatus (the second surface of the substrate 1) according to the present embodiment of the present disclosure is connected to a specific object (being adhered or absorbed to the bottom or the back of the object), and the side adhered to the identifier apparatus is placed on the touch screen of the electronic device (i.e., the terminal device), so that the electronic device can determine the positions of the first electric conductor 3, the second electric conductor 4 and the third electric conductor 5 on the substrate 1 on the touch screen of the electronic device through the touch screen thereof when the first electric conductor 3, the second electric conductor 4 and the third electric conductor 5 on the substrate 1 contact with the touch screen of the electronic device. Here, it needs to be noted that, the touch screen of the electronic device may be a capacitive touch screen. In this case, since the first electric conductor 3, the second electric conductor 4 and the third electric conductor 5 are electric conductors, when the first electric conductor 3, the second electric conductor 4 and the third electric conductor 5 contact with or come close to the touch screen of the electronic device, the capacitance at the contacted or close position will be influenced, and thus the electronic device may determine the contact positions of the first electric conductor 3, the second electric conductor 4 and the third electric conductor 5 on the touch screen.

Then, the electronic device may determine the structure (shape) of the triangle composed of the first electric conductor 3, the second electric conductor 4 and the third electric conductor 5 based on the positions of the first electric conductor 3, the second electric conductor 4 and the third electric conductor 5 on the touch screen. In particular, the sides of the triangle as well as the included angles between the sides may be obtained according to the positions of the first electric conductor 3, the second electric conductor 4 and the third electric conductor 5 on the touch screen, so that the shape of the triangle will be obtained. Then, after the electronic device determines the shape of the triangle composed of the first electric conductor 3, the second electric conductor 4 and the third electric conductor 5, the electronic device may determine the type and/or model of the object to which the identifier apparatus is adhered, based on the structure (shape) of the triangle. Here, identifying information corresponding to the triangle composed of the first electric conductor 3, the second electric conductor 4 and the third electric conductor 5 on the identifier apparatus may be pre-stored in the electronic device (for example, in a storage). In this case, after the electronic device obtains the shape of the triangle composed of the first electric conductor 3, the second electric conductor 4 and the third electric conductor 5, the electronic device may compare the shape of the triangle with the pre-stored identifying information, and determine the type and/or model of the object contacting with the touch screen when the match thereof is found.

In addition, in another example, the electronic device may further determine the placing direction of the object based on the orientation of the structure (shape) of the triangle composed of the first electric conductor 3, the second electric conductor 4 and the third electric conductor 5. Here, since the electronic device has identified the shape of the triangle and the object corresponding thereto, the placing direction of the object may be determined by identifying the direction of the vertex of the triangle composed of the third electric conductor 5, or the orientation of the triangle may be determined by the included angle between the connecting line formed between the first electric conductor 3 and the second electric conductor 4 and a horizontal reference line. Here, it needs to be noted that, it needs to associate the orientation of the shape of the triangle composed of the first electric conductor 3, the second electric conductor 4 and the third electric conductor 5 on the identifier apparatus with the orientation of the object to which the identifier apparatus is adhered (for example, the pointing direction of one vertex of the triangle is consistent with the horizontal or vertical direction of the object), so that the electronic device may determine the placing direction of the object by identifying the orientation of the triangle.

The above is described by taking the pit array 2 being 4×4 pit array as an example. Here, the pit array 2 is not limited to the 4×4 pit array as shown in FIGS. 3A and 3B. The pit array 2 may have other number of rows or columns as long as it is allowed that the three electric conductors on the pits in the pit array may compose a triangle and the positions of the three electric conductors are reasonably selected so as to avoid the triangle from being repeated.

In addition, according to the present embodiment of the present disclosure, the substrate as shown in FIG. 3A or 3B may be a conductive substrate, and the electric conductor may be set on the preset pits on the first surface of the substrate by means of magnetic connection (the electric conductor or substrate is a magnet). In addition, the substrate may be a nonconductive substrate, while the electric conductor may be connected with the substrate by means of adhering.

The identifier apparatus according to the present embodiment of the present disclosure is described above. In the above embodiment, the identifier apparatus may be adhered to a specific object to identify the specific object. However, the present disclosure is not limited thereto. Further, the identifier apparatus may be directly formed on a specific device. Below will be a description of a specific device according to the present embodiment of the present disclosure. Here, the specific device according to the present embodiment of the disclosure (for example, a smart mobile phone, a TPC, a cup and so forth) may comprise a casing. Here, the identifier apparatus may be set on the specific surface of the casing of the specific device. For example, the identifier apparatus may be solidified on the surface of the casing such as the back or the bottom of the specific device.

Here, similar to the previous description, the identifier apparatus may comprise a substrate. The substrate has a first surface. Here, it needs to be noted that, the substrate of the identifier apparatus may be a substrate being solidified on the specific surface of the casing, or may be a part of the specific surface of the casing. At least one electric conductor is implemented by any conductive material, and is set on the preset area of the first surface of the substrate. Here, when the specific device contacts with the touch screen of the electronic device (for example, an information kiosk with a touch screen) to make the touch screen of the electronic device contact with the surface including the identifier apparatus and when the touch screen sensors the at least one electric conductor, the at least one electronic conductor composes an identity that makes the electronic device to identify the specific device uniquely.

Here, similar to the previous description, a pit array may be set on the first surface of the substrate, and at least one electric conductor is set on the preset pits in the pit array, and thus the at least one electric conductor on the preset pits may form a predetermined shape. Here, the substrate may be a conductive substrate, and the at least one electric conductor is set on the preset pits on the first surface of the substrate by means of magnetic connection (the electric conductor or the substrate is a magnet). In this case, the predetermined shapes composed of the at least one electric conductor on the identifier apparatus on different specific devices needs to be different, and thus the at least one electric conductors on the identifier apparatus on different specific devices may form an identity for making the electronic device to identify the specific device uniquely. Here, the pit array may be M×N pit array. For example, one conductor in the M×N pit array may represent that the specific device corresponding to the identifier apparatus is a mobile phone, while two conductors (the two form a straight line) in the M×N pit array may represent a cup and so on.

In addition, in another example, a structure of a triangle may be formed using three electric conductors to identify different devices. In this case, for the M×N pit array, t M is preferably larger than or equal to 3 and N is larger than or equal to 3. Below will be a description by taking the identifier apparatus having the M×N pit array as an example.

Here, the identifier apparatus of the specific device may comprise a substrate, a pit array, a first electric conductor, a second electric conductor, and a third electric conductor. Here, the first electric conductor, the second electric conductor and the third electric conductor may be set respectively on different pits in the pit array, and the first electric conductor, the second electric conductor and the third electric conductor form a triangular structure. Here, the thicknesses of the first electric conductor, the second electric conductor and the third electric conductor need to be greater than the depth of the pit in the pit array, so that the first electric conductor, the second electric conductor and the third electric conductor can contact with the touch screen of the electronic device respectively when the surface of the specific device having the identifier apparatus solidified thereon contacts with the touch screen of the electronic device, thereby the electronic device can sense the first electric conductor, the second electric conductor and the third electric conductor. Thus, the shape of the triangle composed of the first electric conductor, the second electric conductor and the third electric conductor may be determined based on the positions of the first electric conductor, the second electric conductor and the third electric conductor on the touch screen and the type of the specific device having the identifier apparatus solidified thereon may be determined.

In addition, there may be a possibility that the positions of the first electric conductor, the second electric conductor and the third electric conductor are different but the shapes of the triangles being composed thereof are of the same, due to the random arrangement of the first electric conductor, the second electric conductor and the third electric conductor in the pit array. Therefore, according to another example of the present embodiment of the present disclosure, the positions of the first electric conductor and the second electric conductor may be fixed, and a type and/or a model of the specific device corresponding to the identifier apparatus may be determined according to the position of the third electric conductor. For example, similar to the descriptions of FIGS. 3A and 3B, the first electric conductor and the second electric conductor may be set in the downmost row of the pit array, and the first electric conductor and the second electric conductor may be set at two ends of the same row respectively. In this case, since the two points in the triangle composed of the first electric conductor, the second electric conductor and the third electric conductor have been fixed and one side of the composed triangle has been fixed, triangles with different shapes may be formed by changing the position of the third electric conductor. In this case, triangles with different shapes may represent the type and/or model of the specific device corresponding to the identifier apparatus, and the identifier apparatuses having different shapes of triangles may be assigned with respect to the type and/or model of the specific device, so that the electronic device can identify them.

In addition, the orientation of the structure (shape) of the triangle composed of the first electric conductor 3, the second electric conductor 4 and the third electric conductor 5 may further be used for determining the placing direction of the specific device. Here, since different shapes of triangles correspond to different specific devices and the two points of the triangles are fixed, the placing direction of the specific object may be determined through identifying the direction of the vertex of the triangle composed of the third electric conductor, or the orientation of the triangle may be determined through the included angle between the connecting line formed between the first electric conductor 3 and the second electric conductor 4 and a horizontal reference line. Here, it needs to be noted that, it needs to associate the orientation of the shape of the triangle composed of the first electric conductor 3, the second electric conductor 4 and the third electric conductor 5 on the identifier apparatus with the orientation of the specific device (for example, the pointing direction of one vertex of the triangle is consistent with the horizontal or vertical direction of the specific device), so that the electronic device may determine the placing direction of the specific device through identifying the orientation of the triangle.

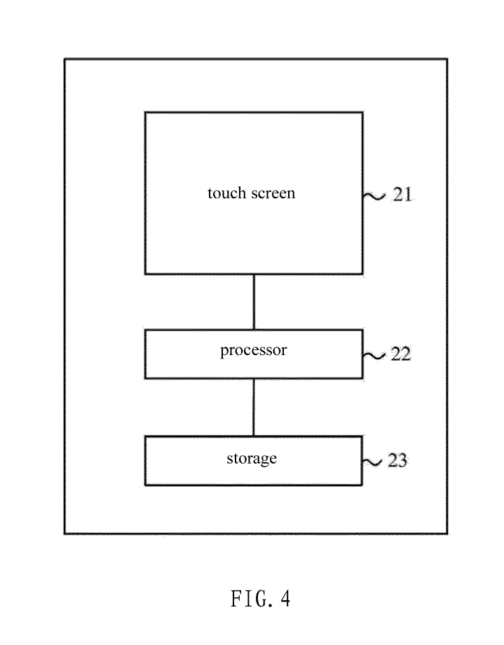

Next, the electronic device according to the embodiment of the present disclosure will be described with reference to FIG. 4. Here, the electronic device may be an information kiosk having a touch screen.

As shown in FIG. 4, the electronic device (i.e., the terminal device) according to the embodiment of the electronic device may comprise a touch screen 21, a processor 22 and storage 23.

The touch screen 21 may be implemented by any capacitive touch screen, and may sense an object (for example, an electric conductor) contacting with or being close to the touch screen.

The processor 22 may be implemented by any processor or microprocessor. The processor 22 may determine the contact or close position based on the touch screen under the control of the preset touch applications.

The storage 23 may be implemented by a flash memory or hardware, and may store multiple pieces of identifying information. Here, each piece of identifying information is used for indicating one individual object, and each piece of identifying information may correspond to a specific shape (i.e., the shape composed of at least one electric conductor on the identifier apparatus).

In the present embodiment, when the specific object having the identifier apparatus contacts with the touch screen 21 of the electronic device, the touch screen 21 will sense at least one contact point. Here, the at least one contact point is formed by at least one electric conductor on the identifier apparatus of the specific object. Then, the processor 22 determines a first shape according to the sensed at least one point contact, and compares the first shape with the plurality pieces of identifying information. Then, the processor 22 may determine the type or model of the specific object based on the comparison result.

Here, it needs to be noted that, the identifier apparatus comprises a substrate. A pit array is arranged on the first surface of the substrate. Here, the at least one electric conductor is set on the preset pits in the pit array. Similar to the previous description, the pit array may be set on the first surface of the substrate, and at least one electric conductor is set on the preset pits in the pit array, and thus the at least one electric conductor on the preset pits may form a predetermined shape. Here, the substrate may be a conductive substrate, and the at least one electric conductor is set on the preset pits on the first surface of the substrate by means of magnetic connection (the electric conductor or the substrate is a magnet). Here, the pit array may be M×N pit array. In addition, in another example, three electric conductors may be used to form a triangular structure, so as to identify different devices. In this case, for the M×N pit array, M is preferably larger than or equal to 3 and N is larger than or equal to 3. Below will be a description by taking the identifier apparatus having the M×N pit array as an example. Here, similar to the previous description, the identifier apparatus may comprise a first electric conductor, a second electric conductor and a third electric conductor, and the three electric conductors compose a triangular structure. In another example, the positions of the first electric conductor and the second electric conductor may be fixed, and a type and/or a model of the specific device corresponding to the identifier apparatus may be determined through the position of the third electric conductor. For example, similar to the descriptions to FIGS. 3A and 3B, the first electric conductor and the second electric conductor may be set in the downmost row of the pit array, and the first electric conductor and the second electric conductor are set at two ends of the same row respectively. In this case, since the two points in the triangle composed of the first electric conductor, the second electric conductor and the third electric conductor have been fixed and one side of the composed triangle has been fixed, triangles with different shapes may be formed by changing the position of the third electric conductor. In this case, triangles with different shapes may represent the type and/or model of the specific device corresponding to the identifier apparatus, and the identifier apparatuses having different shapes of triangles may be assigned with respect to the type and/or model of the specific device, so that the electronic device can identify them.

In this case, the side to which the identifier apparatus is adhered is placed on the touch screen of the electronic device, such that the processor can determine the positions of the contact points of the first electric conductor, the second electric conductor and the third electric conductor on the touch screen when the first electric conductor, the second electric conductor and the third electric conductor on the substrate of the identifier apparatus are sensed by the touch screen of the electronic device. Here, it needs to be noted that, the touch screen of the electronic device may be a capacitive touch screen. In this case, since the first electric conductor, the second electric conductor and the third electric conductor are electric conductors, the capacitance at the position of a contact will be influenced when the first electric conductor, the second electric conductor and the third electric conductor contact with or come close to the touch screen of the electronic device, and thus the processor may determine the contact positions of the first electric conductor, the second electric conductor and the third electric conductor on the touch screen.

Then, the electronic device may determine the structure (shape) of the triangle composed of the first electric conductor, the second electric conductor and the third electric conductor based on the positions of the contact points of the first electric conductor, the second electric conductor and the third electric conductor on the touch screen. In particular, the sides of the triangle and the included angles between the sides may be obtained according to the positions of the first electric conductor, the second electric conductor and the third electric conductor on the touch screen, such that the shape of the triangle will be obtained.

Then, the processor 22 compares the structure of the triangle with the plurality pieces of identifying information stored in the storage unit 23, and determines the type or model of the specific object based on the comparison result. In particular, identifying information corresponding to the triangle composed of the first electric conductor, the second electric conductor and the third electric conductor on the identifier apparatus of the specific object may be pre-stored in the storage 23 of the electronic device. In this case, after the electronic device obtains the shape of the triangle composed of the first electric conductor, the second electric conductor and the third electric conductor, the electronic device can compare the shape of the triangle with the pre-stored identifying information, and determine the type and/or model of the object contacting with the touch screen when the match thereof is found.

In addition, in another example, the processor 22 may further determine the placing direction of the object based on the orientation of the structure (shape) of the triangle being composed of the first electric conductor, the second electric conductor and the third electric conductor. Here, since the processor 22 has identified the shape of the triangle being composed of the three electric conductors on the identifier apparatus, the processor 22 may determine the placing direction of the object through identifying the direction of the vertex of the triangle composed of the third electric conductor, or the orientation of the triangle may be determined through the included angle between the connecting line formed between the first electric conductor and the second electric conductor and a horizontal datum line. Here, it needs to be noted that, it needs to associate the orientation of the shape of the triangle composed of the first electric conductor, the second electric conductor and the third electric conductor on the identifier apparatus with the orientation of the specific object to which the identifier apparatus is adhered (for example, the pointing direction of one vertex of the triangle is consistent with the horizontal or vertical direction of the specific object), such that the processor 22 may determine the placing direction of the specific object through identifying the orientation of the triangle.

The embodiments of the present disclosure have been described above in detail. Those skilled in the art should understand that various modifications, combinations, partial combinations and alternations may be made to the disclosure depending on the design requirement and other factors, as long as they are within the scope of the appended claims and their equivalents.

It should be noted that, in this specification, the terms “comprising”, “including” or any other variant are intended to cover a non-exclusive inclusion, so that the process, method, article or device comprising a series of elements comprises not only those elements, but also comprises other elements not expressly listed, or further comprises elements inherent in this process, method, article, or device. In the case of no more restrictions, the elements defined by the statement “comprises a . . . ”, do not preclude the existence of additional identical elements in the process, method, article or device comprising the elements.

Finally, it should be noted that, the above-described series of processes comprise not only the processes performed in time series in the order described herein, but also comprise the processes performed concurrently or separately, instead of in chronological order.

Through the above description of the embodiments, the skilled in the art can clearly understand that the present invention can be implemented by means of software plus a necessary hardware platform; certainly, it can also be implemented entirely by hardware. Based on such understanding, all or part of the contribution of the technical solution of the present invention to the background art, may be embodied in the form of a software product, which can be stored in a storage medium, such as a ROM/RAM, hard disk, optical disk, etc., comprising a plurality of instructions for allowing a computer device (which may be a personal computer, a server, or a network device, etc.) to perform the methods described in various embodiments or in some portion of the embodiments of the present invention.

The above has described the present invention in detail, and specific examples are used herein to explain the principles and embodiments of the invention. However, the above description of the embodiments is only used to help understanding the methods and core ideas of the present invention; meanwhile, for the ordinary skilled in the art, based on the ideas of the invention, variations can be made both in implementations and application ranges; in summary, the content of this specification should not be understood as limitative to the present invention.

What is claimed:

1. A method for acquiring information, applied to an electronic device comprising a wireless receiving apparatus capable of receiving information from a trigger object, and a display screen, the trigger object comprising at least three surfaces each of which has a corresponding wireless communication apparatus, the method comprising:
detecting trigger information from the wireless communication apparatus in the trigger object;
determining a first surface among the at least three surfaces corresponding to the trigger information, based on the trigger information;
acquiring first wireless RF (Radio Frequency) information transmitted from the wireless communication apparatus corresponding to the first surface; and
determining data information on the first surface corresponding to the first wireless RF information, according to the correspondence between wireless RF information and surface information.

2. The method of claim 1, wherein, the wireless communication apparatus is a Near Field Communication (NFC) apparatus.

3. The method of claim 2, wherein, the step of acquiring first wireless RF information transmitted from the wireless communication apparatus corresponding to the first surface comprises:
transmitting to the NFC apparatus starting information for generating the wireless RF information by the NFC apparatus; and
acquiring the wireless RF information generated by the NFC apparatus in the first surface, and determining the first wireless RF information according to the wireless RF information.

4. The method of claim 1, wherein, the correspondence between wireless RF information and surface information is set in such a way that one piece of wireless RF information corresponds to data information on one surface uniquely.

5. The method of claim 4, wherein, the step of determining the first wireless RF information based on the wireless RF information comprises:
obtaining at least two pieces of wireless RF information through a wireless RF information receiving apparatus;
deciding whether the at least two pieces of wireless RF information meet a preset condition or not, to make a decision;
when the decision shows that the two pieces of wireless RF information meet the preset condition, determining the first wireless RF information according to the two pieces of wireless RF information; and
determining the data information on the first surface according to the first wireless RF information.

6. The method of claim 5, further comprising:
when the decision shows that none of the two pieces of wireless RF information meets the preset condition, returning to detect the trigger information from the wireless communication apparatus in the trigger object.

7. The method of claim 6, wherein, the preset condition is that the value of the difference between the at least two pieces of wireless RF information is within a preset range.

8. The method of claim 5, wherein, before the step of deciding whether the at least two pieces of wireless RF information meet a preset condition or not to make a decision, the method further comprises:
deciding whether the time interval between the timings when acquiring the two pieces of wireless RF information meets a preset time interval or not;
if the time interval between the timings when acquiring the two pieces of wireless RF information meets the preset time interval, deciding whether the two pieces of wireless RF information meet the preset condition.

9. An electronic device, comprising:
a detector configured to detect trigger information from a wireless communication apparatus in a trigger object;
a determining module configured to determine a first surface among at least three surfaces corresponding to the trigger information, based on the trigger information;
an information acquiring module configured to acquire first wireless RF (Radio Frequency) information transmitted from the wireless communication apparatus corresponding to the first surface; and
a data information determining module configured to determine data information on the first surface corresponding to the first wireless RF information, according to the correspondence between wireless RF information and surface information.

10. The electronic device of claim 9, wherein, the information acquiring module comprises:
a transmitter configured to transmit to a NFC apparatus starting information for generating the wireless RF information by the NFC apparatus; and
a first determining module configured to acquire the wireless RF information generated by the NFC apparatus in the first surface, and determine the first wireless RF information according to the wireless RF information.

11. An identifier apparatus, comprising:
a substrate having a first surface and a second surface opposite to the first surface; and
at least one electric conductor placed on a preset area of the first surface of the substrate;
wherein, the second surface of the substrate is connectable to a first object; and
the at least one electric conductor forms an identity for identifying the first object, when the at least one electric conductor on the first surface of the substrate is contacted with a touch screen of a terminal device.

12. The identifier apparatus of claim 11, wherein,
a pit array is arranged on the first surface of the substrate, and
the at least one electric conductor is arranged on preset pits in the pit array.

13. The identifier apparatus of claim 12, wherein,
the pit array is a M×N pit array, wherein, M is equal to or larger than 3, and N is equal to or larger than 3.

14. The identifier apparatus of claim 13, wherein,
the identifier apparatus comprises a first electric conductor, a second electric conductor and a third electric conductor; and
the three electric conductor form a triangular structure.

15. The identifier apparatus of claim 14, wherein,
the positions of the first electric conductor and the second electric conductor are fixed; and
the position of the third electric conductor is determined based on the type and/or model of the first object.

16. The identifier apparatus of claim 15, wherein,
the terminal device determines the positions of the first electric conductor, the second electric conductor and the third electric conductor, when the first electric conductor, the second electric conductor and the third electric conductor of the substrate are contacted with a touch screen of the terminal device;
the terminal device determines the triangular structure formed of the first electric conductor, the second electric conductor and the third electric conductor, based on the positions of the first electric conductor, the second electric conductor and the third electric conductor; and
the terminal device determines the type and/or the model of the first object based on the triangular structure.

17. The identifier apparatus of claim 16, wherein,
the terminal device determines the placing direction of the first object based on the orientation of the triangular structure.

18. The identifier apparatus of claim 12, wherein,
the substrate is a conductive substrate; and
the at least one electric conductor is set on the preset pits on the first surface of the substrate by means of magnetic connection.

19. The identifier apparatus of claim 11, wherein,
the touch screen is a capacitive touch screen.
